(19) United States
(12) Patent Application Publication
(10) Pub. No.: US 2025/0105458 A1
(43) Pub. Date: Mar. 27, 2025

(54) POWER STORAGE DEVICE

(71) Applicant: KABUSHIKI KAISHA TOYOTA JIDOSHOKKI, Kariya-shi, Aichi (JP)

(72) Inventors: Tomohiro NAKAMURA, Kariya-shi, Aichi (JP); Takayuki HIROSE, Kariya-shi, Aichi (JP)

(73) Assignee: KABUSHIKI KAISHA TOYOTA JIDOSHOKKI, Kariya-shi, Aichi (JP)

(21) Appl. No.: 18/730,854

(22) PCT Filed: Mar. 6, 2023
(86) PCT No.: PCT/JP2023/008402

§ 371 Date: Jul. 22, 2024

(30) Foreign Application Priority Data
Apr. 1, 2022 (JP) 2022-061946

(51) Int. Cl. H01M 50/477; H01G 11/28; H01M 4/02; H01M 50/46

(52) U.S. Cl. CPC H01M 50/477; H01G 11/28; H01M 50/46; H01M 2004/029

(57) ABSTRACT

In a power storage device, an outer edge portion protruding farther outward than the edge portion of the current collector in each of the spacers and an outer edge portion protruding farther outward than the edge portion of the current collector in each of the seal members adjacent to each of the spacers in the lamination direction are welded to each other to form an outer surface of the sealing body, and a melt mass flow rate of a resin material constituting the spacer is larger than a melt mass flow rate of a resin material constituting the seal member.

### TECHNICAL FIELD

The present disclosure relates to a power storage device.

### BACKGROUND ART

As a conventional power storage device, for example, there is a bipolar battery described in Patent Literature 1. This conventional bipolar battery has a plurality of bipolar electrodes in which a positive electrode active material layer is formed on one surface of a current collector and a negative electrode active material layer is formed on the other surface. These bipolar electrodes are laminated with a gel electrolyte layer interposed therebetween to configure a bipolar battery.

In this conventional bipolar battery, seal members are disposed between the current collectors adjacent to each other in a lamination direction so as to surround a periphery of a single battery layer including a positive electrode active material layer, a gel electrolyte layer, and a negative electrode active material layer. The seal members extend to the outside of the current collectors and are thermally fused to each other at the outside. The seal member is formed of an insulating thermally fusible resin such as polyethylene or polypropylene, and is thermally fused to the current collector or the end current collector before the bipolar electrode is laminated. With such a seal member, each single battery layer is sealed, and prevention of liquid leakage from the single battery layer and prevention of a short circuit due to contact between the current collectors are achieved.

### CITATION LIST

### Patent Literature

Patent Literature 1: Japanese Unexamined Patent Publication No. 2004-319210

### SUMMARY OF INVENTION

### Technical Problem

In the above-described conventional bipolar battery, a portion of the seal member thermally fused to the current collector is sandwiched between the current collectors to prevent a short circuit due to the contact between the current collectors. In addition, portions of the seal member that are thermally fused to each other outside the current collector seal each single battery layer.

In such a configuration, when a material having a low melt mass flow rate is used as a resin material constituting the seal member, a shape in a thickness direction is easily stabilized at the time of thermal fusion to the current collector in the portion thermally fused to the current collector, and a short circuit due to the contact between the current collectors can be suitably prevented. On the other hand, when a material having a low melt mass flow rate is used as the resin material constituting the seal member, fluidity of both the seal members adjacent to each other in the lamination direction is low in the portions thermally fused to each other outside the current collector, and thus there is a possibility that sealing of each single battery layer by the seal member becomes insufficient.

The present disclosure has been made to solve the above problems, and an object of the present disclosure is to provide a power storage device capable of further enhancing sealability of a sealing body while more suitably maintaining an interval between current collectors.

### Solution to Problem

A power storage device according to one aspect of the present disclosure includes: an electrode laminate formed by laminating a plurality of bipolar electrodes including a pair of electrodes configured by a current collector and active material layers provided on a first surface and a second surface of the current collector; and a sealing body that seals a side surface extending in a lamination direction of the bipolar electrodes in the electrode laminate, in which the sealing body has a plurality of frame-like seal members welded to each edge portion of the current collector, and a plurality of frame-like spacers disposed between the seal members adjacent to each other in the lamination direction, an outer edge portion protruding farther outward than the edge portion of the current collector in each of the spacers and an outer edge portion protruding farther outward than the edge portion of the current collector in each of the seal members adjacent to each of the spacers in the lamination direction are welded to each other to form an outer surface of the sealing body, and a melt mass flow rate of a resin material constituting the spacer is larger than a melt mass flow rate of a resin material constituting the seal member.

The melt mass flow rate is a measure representing fluidity when the resin material is melted. In this power storage device, the melt mass flow rate of the resin material constituting the spacer is larger than the melt mass flow rate of the resin material constituting the seal member. By increasing the melt mass flow rate of the resin material constituting the spacer, the fluidity of each spacer when the outer edge portion of each spacer and the outer edge portion of each seal member are welded can be enhanced. Therefore, compatibility between the spacer and the seal member is enhanced, and the sealability of the sealing body can be further enhanced. On the other hand, in the power storage device, since the melt mass flow rate of the seal member welded to the current collector is suppressed, when the seal member is welded to the current collector, the resin material can be suppressed from spreading to the active material layer side on the surface of the current collector. Therefore, in this power storage device, a dimension in a thickness direction of the seal member after welding can be stabilized, and the interval between the current collectors in the lamination direction can be more suitably maintained.

A thickness of the spacer may be larger than a thickness of the seal member. By making the thickness of the spacer having a melt mass flow rate larger than that of the seal member larger than that of the seal member, the compatibility between the seal member and the spacer can be more sufficiently secured. Therefore, welding between the respective outer edge portions of the spacers and the respective outer edge portions of the seal members can easily proceed, and the sealability of the sealing body can be further enhanced.

The seal member may be welded to each of the first surface and the second surface of the current collector. In this case, it is possible to prevent an electrolyte solution from flowing around to another surface of the current collector and to suppress an occurrence of electrolytic corrosion. Even when the seal member is disposed on each of the first surface and the second surface of the current collector and then welded by pressurization and heating from both the first surface side and the second surface side, since the melt mass flow rate of the seal member welded to the current collector is smaller than the melt mass flow rate of the resin material constituting the spacer, it is possible to sufficiently suppress the spread of the resin material when the seal member is welded to the current collector. Therefore, the stability of the dimension in the thickness direction of the seal member after welding can be more suitably maintained.

### Advantageous Effects of Invention

According to the present disclosure, the sealability of the sealing body can be further enhanced while more suitably maintaining the interval between the current collectors.

### BRIEF DESCRIPTION OF DRAWINGS

FIG. 1 is a schematic cross-sectional view illustrating a power storage device according to one embodiment of the present disclosure.

FIG. 2 is a schematic enlarged cross-sectional view of a main part of the power storage device illustrated in FIG. 1.

FIG. 3(a) is a schematic cross-sectional view illustrating a state of welding of a seal member to a current collector, (b) illustrates a state in a comparative example, and (c) illustrates a state in an example.

FIG. 4 is a schematic cross-sectional view illustrating a state of welding between a seal member and a spacer.

### DESCRIPTION OF EMBODIMENTS

Hereinafter, a preferred embodiment of a power storage device according to one aspect of the present disclosure will be described in detail with reference to the drawings.

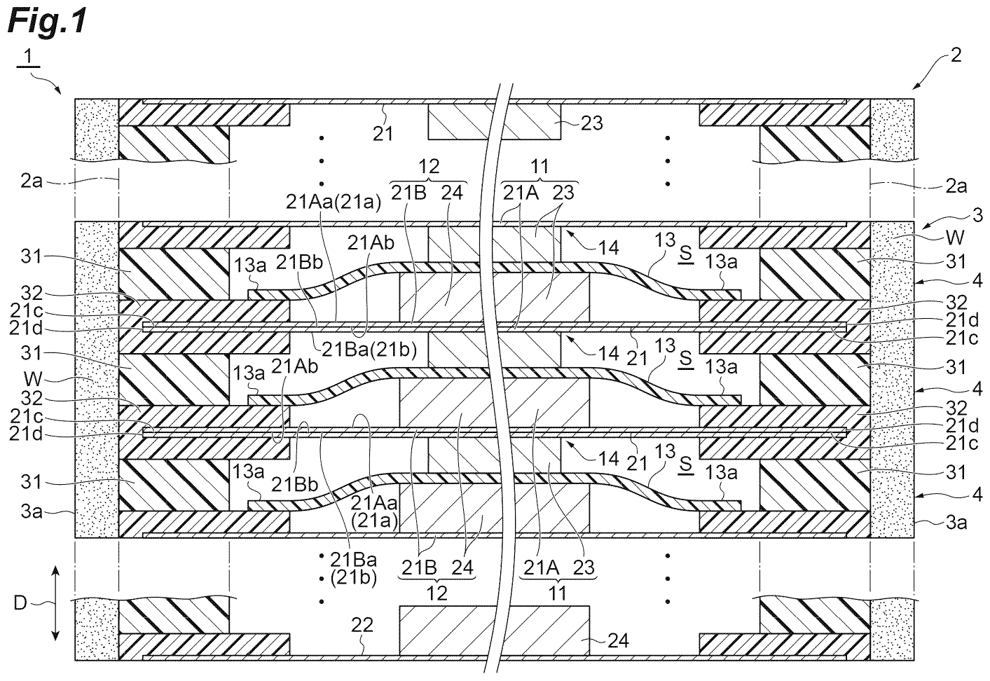

FIG. 1 is a schematic cross-sectional view illustrating a power storage device according to one embodiment of the present disclosure. A power storage device 1 illustrated in FIG. 1 is a device used for a battery of various vehicles such as a forklift, a hybrid vehicle, and an electric vehicle. The power storage device 1 is, for example, a secondary battery such as a nickel-metal hydride secondary battery and a lithium-ion secondary battery. The power storage device 1 may be an electric double-layer capacitor or an all-solid-state battery. In the present embodiment, a case where the power storage device 1 is a lithium-ion secondary battery will be exemplified.

The power storage device 1 includes an electrode laminate 2 formed by laminating a plurality of bipolar electrodes 14, and a sealing body 3 which seals a side surface 2a extending in a lamination direction D of the bipolar electrodes 14 in the electrode laminate 2. As illustrated in FIG. 1, the electrode laminate 2 includes a plurality of cells 4. Each cell 4 has a positive electrode 11, a negative electrode 12, and a separator 13.

The positive electrode 11 and the negative electrode 12 have, for example, a rectangular shape when viewed from the lamination direction. The positive electrode 11 and the negative electrode 12 are disposed to face each other with the separator 13 interposed therebetween. The facing direction of the positive electrode 11 and the negative electrode 12 coincides with the lamination direction D of the bipolar electrodes 14. The positive electrode 11 includes a current collector 21 and a positive electrode active material layer 23 provided on a first surface 21a side of the current collector 21. The negative electrode 12 includes a current collector 21 and a negative electrode active material layer 24 provided on a second surface 21b side of the current collector 21. Here, the first surface 21a of the current collector 21 is a surface facing a negative electrode terminal electrode described later, and the second surface 21b of the current collector 21 is a surface facing a positive electrode terminal electrode described later (see FIG. 1).

The current collector 21 is a chemically inactive electric conductor for continuously flowing a current through the positive electrode active material layer 23 and the negative electrode active material layer 24 during discharge or charge of the lithium-ion secondary battery. In the present embodiment, the current collector 21 has a two-layer structure formed by superimposing a first current collector 21A for the positive electrode 11 and a second current collector 21B for the negative electrode 12. A first surface 21Aa of the first current collector 21A is a surface corresponding to the first surface 21a of the current collector 21 combining the first current collector 21A and the second current collector 21B. A first surface 21Ba of the second current collector 21B is a surface corresponding to the second surface 21b of the current collector 21 combining the first current collector 21A and the second current collector 21B.

In the present embodiment, the plurality of cells 4 are laminated such that the first current collector 21A of one cell 4 and the second current collector 21B of another cell 4 are in contact with each other. Thus, the plurality of cells 4 are electrically coupled in series to configure the electrode laminate 2 described above. In the cells 4 and 4 adjacent to each other in the lamination direction D, the bipolar electrode 14 in which the first current collector 21A and the second current collector 21B in contact with each other serve as one current collector 21 is formed. That is, the electrode laminate 2 includes the plurality of bipolar electrodes 14 laminated in the lamination direction D. A terminal electrode (positive electrode terminal electrode) including the first current collector 21A is disposed at one end of the electrode laminate 2 in the lamination direction D. A terminal electrode (negative electrode terminal electrode) including the second current collector 21B is disposed at the other end of the electrode laminate 2 in the lamination direction D.

Examples of the material constituting the first current collector 21A and the second current collector 21B include a metal material, a conductive resin material, and a conductive inorganic material.

Examples of the conductive resin material include a conductive polymer material, a resin obtained by adding a conductive filler to a non-conductive polymer material, and the like. The first current collector 21A and the second current collector 21B may include a plurality of layers including one or more layers including the above-described metal material or conductive resin material. A coating layer may be formed on the surfaces of the first current collector 21A and the second current collector 21B by a known method such as plating treatment or spray coating.

The first current collector 21A and the second current collector 21B may be formed in, for example, a plate shape, a foil shape, a sheet shape, a film shape, a mesh shape, and the like. When the first current collector 21A and the second current collector 21B are metal foils, for example, an aluminum foil, a copper foil, a nickel foil, a titanium foil, or a stainless steel foil is used. The first current collector 21A and the second current collector 21B may be an alloy foil or a clad foil of the metal. When the first current collector 21A and the second current collector 21B are in a foil shape, each of the first current collector 21A and the second current collector 21B may be in a range of 1 μm or more and 100 μm or less.

In the present embodiment, the first current collector 21A is an aluminum foil, and the second current collector 21B is a copper foil. The current collector 21 may be, for example, a laminated foil in which a copper plating layer as the second current collector 21B is formed on one surface of the aluminum foil as the first current collector 21A. The current collector 21 may be, for example, a bonded foil in which the aluminum foil as the first current collector 21A and a copper foil as the second current collector 21B are bonded and integrated.

The positive electrode active material layer 23 is provided on the first surface 21Aa of the rectangular first current collector 21A in a rectangular shape with a dimension smaller than that of the first surface 21Aa. The negative electrode active material layer 24 is provided on the first surface 21 Ba of the rectangular second current collector 21B in a rectangular shape with a dimension slightly smaller than the first surface 21Ba. In other words, in an edge portion 21c of the current collector 21, a region where the positive electrode active material layer 23 is not provided is formed on the first surface 21Aa side, and a region where the negative electrode active material layer 24 is not provided is formed on the first surface 21Ba side. The negative electrode active material layer 24 is formed slightly larger than the positive electrode active material layer 23. When viewed from the lamination direction D, the entire formation region of the positive electrode active material layer 23 is located in the formation region of the negative electrode active material layer 24.

The positive electrode active material layer 23 includes a positive electrode active material capable of occluding and releasing charge carriers such as lithium ions. Examples of the positive electrode active material include a composite oxide, metal lithium, sulfur, and the like. The composition of the composite oxide includes, for example, at least one of iron, manganese, titanium, nickel, cobalt, and aluminum, and lithium. Examples of the composite oxide include olivine type lithium iron phosphate (LiFePO₄), LiCoO₂, LiNiMnCoO₂, and the like.

The negative electrode active material layer 24 includes a negative electrode active material capable of occluding and releasing charge carriers such as lithium ions. Examples of the negative electrode active material include graphite, artificial graphite, highly oriented graphite, mesocarbon microbeads, carbon such as hard carbon and soft carbon, metal compounds, elements capable of being alloyed with lithium or compounds thereof, boron-added carbon, and the like. Examples of the element that can be alloyed with lithium include silicon and tin.

The positive electrode active material layer 23 and the negative electrode active material layer 24 may include a binder and a conductive auxiliary agent in addition to the active material. The binder plays a role of connecting the active material or the conductive auxiliary agent to each other and maintaining the conductive network in the electrode. Examples of the binder include fluorine-containing resins such as polyvinylidene fluoride, polytetrafluoroethylene, and fluororubber, thermoplastic resins such as polypropylene and polyethylene, imide resins such as polyimide and polyamideimide, alkoxysilyl group-containing resins, acrylic resins such as polyacrylic acid and polymethacrylic acid, alginates such as styrene-butadiene rubber, carboxymethyl cellulose, sodium alginate, and ammonium alginate, water-soluble cellulose ester crosslinked products, and starch-acrylic acid graft polymers. The binder thereof can be used alone or in combination. The conductive auxiliary agent is, for example, a conductive material such as acetylene black, Cahn black, and graphite, and can enhance electrical conductivity. As a viscosity adjusting solvent, for example, N-methyl-2-pyrrolidone or the like is used.

For forming the positive electrode active material layer 23 and the negative electrode active material layer 24 on the current collector 21, conventionally known methods such as a roll coating method, a die coating method, a dip coating method, a doctor blade method, a spray coating method, and a curtain coating method are used. Specifically, an active material, a solvent, and if necessary, a binder and a conductive auxiliary agent are mixed to produce a slurry-like active material layer forming composition, and the active material layer forming composition is applied to the current collector 21 and then dried. As the solvent, for example, N-methyl-2-pyrrolidone, methanol, methyl isobutyl ketone, water, or the like can be used. In order to enhance the electrode density, the active material layer forming composition after drying may be compressed.

The separator 13 is disposed between the positive electrode 11 and the negative electrode 12 in the lamination direction D. The separator 13 is a member that separates the positive electrode 11 and the negative electrode adjacent to each other in the electrode laminate 2, thereby allowing charge carriers such as lithium ions to pass while preventing an electrical short circuit due to contact between both electrodes. The separator 13 is disposed between the positive electrode active material layer 23 and the negative electrode active material layer 24 facing each other in the lamination direction D.

The separator 13 has a rectangular shape slightly larger than the positive electrode active material layer 23 and the negative electrode active material layer 24 and slightly smaller than the current collector 21 when viewed from the lamination direction D. An end portion 13a of the separator 13 is located outside the positive electrode active material layer 23 and the negative electrode active material layer 24 when viewed from the lamination direction D, and is welded to a seal member 32 described later on the first surface 21a side of the current collector 21.

The separator 13 is formed in a sheet shape, for example. The separator 13 is made of, for example, a porous sheet or a nonwoven fabric including a polymer that absorbs and holds an electrolyte. Examples of the material constituting the separator 13 include polypropylene, polyethylene, polyolefin, polyester, and the like. The separator 13 may have a single layer structure or a multilayer structure. In a case of the multilayer structure, the separator 13 may include, for example, a base material layer and a pair of adhesive layers, and may be adhesively fixed to the positive electrode active material layer 23 and the negative electrode active material layer 24 by the pair of adhesive layers. The separator 13 may include a ceramic layer serving as a heat resistant layer. The separator 13 may be reinforced with a vinylidene fluoride resin compound.

Examples of the electrolyte with which the separator 13 is impregnated include a liquid electrolyte (electrolytic solution) containing a nonaqueous solvent and an electrolyte salt dissolved in the nonaqueous solvent, and a polymer gel electrolyte containing an electrolyte held in a polymer matrix. When the separator 13 is impregnated with an electrolyte, known lithium salts such as LiClO₄, LiAsF₆, LiPF₆, LiBF₄, LiCF₃SO₃, LiN(FSO₂)₂, LiN(CF₃SO₂)₂, and the like can be used as the electrolyte salt. As the nonaqueous solvent, known solvents such as cyclic carbonates, cyclic esters, chain carbonates, chain esters, and ethers can be used. Two or more of these known solvent materials may be used in combination.

The sealing body 3 is a member that seals the side surface 2a extending in the lamination direction D of the bipolar electrodes 14 in the electrode laminate 2. The sealing body 3 seals a space S between the current collectors 21 and 21 adjacent to each other in the lamination direction D. The space S is defined by the current collectors 21 and 21 adjacent to each other in the lamination direction D and the sealing body 3. An electrolyte is accommodated in the space S.

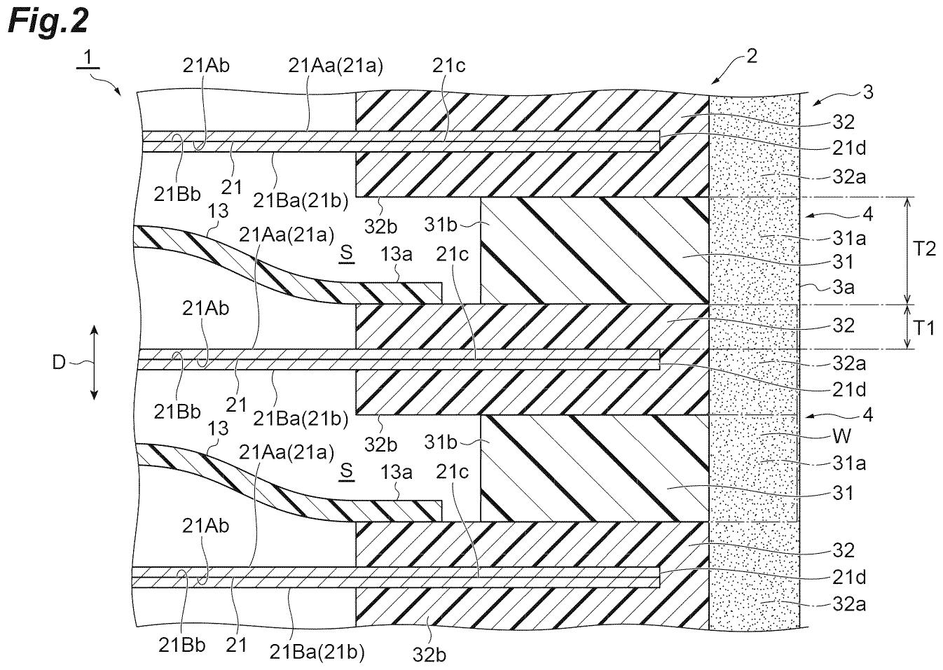

The sealing body 3 includes a plurality of frame-like spacers 31 and a plurality of frame-like seal members 32. The spacer 31 is disposed between the current collectors 21 and 21 adjacent to each other in the lamination direction D. The spacer 31 is disposed between the seal members 32 and 32 adjacent to each other in the lamination direction D. The seal member 32 is welded to each edge portion 21c of the current collector 21. In the present embodiment, as illustrated in FIG. 2, the seal member 32 is provided so as to cover the edge portion 21c of the current collector 21, that is, the seal member 32 is located on both the first surface 21a side and the second surface 21b side in the edge portion 21c of the current collector 21, and is also located on a side end surface 21d of the current collector 21 so as to connect these.

The seal member 32 is welded to the first surface 21a at the entire overlapping portion with the first surface 21a, and is welded to the second surface 21b at the entire overlapping portion with the second surface 21b. The seal member 32 may be welded to the entire side end surface 21d of the current collector 21 or may be welded to only a part thereof. The seal member 32 is not necessarily welded to the side end surface 21d. In this case, the seal member 32 may be in contact with the side end surface 21d or may be slightly separated from the side end surface 21d.

The spacer 31 is a portion that also functions as a member that maintains an interval between the current collectors 21 and 21 adjacent to each other in the lamination direction D. The spacer 31 is disposed between the seal members 32 and 32 covering the respective edge portions 21c of the current collectors 21 and 21 adjacent to each other in the lamination direction D. A thickness T2 of the spacer 31 is larger than a thickness T1 of the seal member 32.

In the present embodiment, the seal member 32 is provided so as to cover the edge portion 21c of the current collector 21, but the thickness T1 of the seal member 32 is defined by a thickness of a portion located on the first surface 21a of the current collector 21 (or a thickness of a portion located on the second surface 21b of the current collector 21). The thickness T2 of the spacer 31 is defined by a thickness of a portion located between the seal members 32 and 32 adjacent to each other in the lamination direction D. A ratio of the thickness T2 of the spacer 31 to the thickness T1 of the seal member 32 is, for example, 1:2 to 1:4.

Both an outer edge portion 32a of the seal member 32 and an outer edge portion 31a of the spacer 31 slightly protrude farther outward than the edge portion 21c of the current collector 21 as viewed from the lamination direction D. When viewed from the lamination direction D, the outer edge portion 31a of each spacer 31 protruding farther outward than the edge portion 21c of the current collector 21 and the outer edge portion 32a of each seal member 32 adjacent to each spacer 31 in the lamination direction D protruding farther outward than the edge portion 21c of the current collector 21 are welded to each other to form a welded portion W, and the welded portion W forms the outer surface 3a of the sealing body 3. More specifically, the portion including the end surface of the outer edge portion 31a of each spacer 31 and the portion including the end surface of the outer edge portion 32a of each seal member 32 are integrated by welding to configure the welded portion W extending in the lamination direction D. For welding between the outer edge portion 31a of the spacer 31 and the outer edge portion 32a of the seal member 32, for example, a method such as infrared ray welding or hot plate welding can be used. In the welded portion W, the sealing properties of the space S between the current collectors 21 and 21 adjacent to each other in the lamination direction D is secured by the compatibility between the resin material constituting the seal member 32 and the resin material constituting the spacer 31.

Inside the welded portion W, the spacer 31 is not welded to both the seal member 32 on the first surface 21a side of one current collector 21 and the seal member 32 on the second surface 21b side of the other current collector 21 adjacent to each other in the lamination direction D. In a non-welded portion, the spacer 31 and the seal member 32 on the first surface 21a side of the current collector 21 may be in contact with each other or may be slightly separated from each other. Similarly, in the non-welded portion, the spacer 31 and the seal member 32 on the second surface 21b side of the current collector 21 may be in contact with each other or may be slightly separated from each other. The spacer 31 is not welded to any of the current collectors 21 and 21 adjacent to each other in the lamination direction D.

In the present embodiment, an inner edge portion 32b of the seal member 32 protrudes further inward of the current collector 21 (that is, the active material layer side) than an inner edge portion 31b of the spacer 31. Here, the inner edge portion 32b of the seal member 32 and the inner edge portion 31b of the spacer 31 are both portions overlapping the current collector 21 when viewed from the lamination direction D. That is, the inner edge portion 31b of the spacer 31 overlaps the seal member 32 on the first surface 21a side of the current collector 21 and the seal member 32 on the second surface 21b side of the current collector 21 inside the welded portion W when viewed from the lamination direction D. On the first surface 21a side of the current collector 21, the end portion 13a of the separator 13 described above is welded to the protruding portion of the inner edge portion 32b of the seal member 32 from the inner edge portion 31b of the spacer 31. The inner edge portion 31b of the spacer 31 may protrude further inward of the current collector 21 (that is, the active material layer side) than the inner edge portion 32b of the seal member 32 when viewed from the lamination direction D.

Examples of the resin material constituting the seal member 32 and the spacer 31 include materials having electrolyte resistance such as acid-modified polyethylene (acid-modified PE), acid-modified polypropylene (acid-modified PP), polyethylene, and polypropylene. The resin material constituting the seal member 32 and the resin material constituting the spacer 31 may be the same or different.

In the present embodiment, the resin material constituting the seal member 32 is acid-modified polyethylene or acid-modified polypropylene, and the resin material constituting the spacer 31 is polyethylene or polypropylene. The acid-modified polyethylene and the acid-modified polypropylene have a property of easily adhering to metal as compared with polyethylene which is not acid-modified and polypropylene which is not acid-modified. In the present embodiment in which the current collector 21 is made of a metal foil such as a copper foil or an aluminum foil, the adhesive strength (bonding strength) to the current collector 21 can be improved by configuring the seal member 32 with the acid-modified polyethylene or the acid-modified polypropylene. In the spacer 31 which is not required to be adhered to the current collector 21, cost reduction of the power storage device 1 can be achieved by using inexpensive polyethylene or polypropylene.

The melt mass flow rate of the resin material constituting the spacer 31 is larger than the melt mass flow rate of the resin material constituting the seal member 32. The melt mass flow rate is a measure representing fluidity when the resin material is melted. In the present embodiment, the melt mass flow rate is measured at a temperature of 230° C. and a load of 2.16 kg in accordance with JIS K 7210 (ISO1133). As an example, the melt mass flow rate of the resin material constituting the seal member 32 is 1 g/10 min to 10 g/10 min, and the melt mass flow rate of the resin material constituting the spacer 31 is 5 g/10 min to 15 g/10 min.

As another example, when polyethylene is used as the resin material constituting the seal member 32 and the spacer 31, the melt mass flow rate of the resin material constituting the seal member 32 may be set to be smaller than 1 g/10 min, and the melt mass flow rate of the resin material constituting the spacer 31 may be set to be 1 g/10 min to 5 g/10 min. As described above, by setting the melt mass flow rate of the resin material such as polyethylene or polypropylene constituting the seal member 32 to a relatively small value among the resin materials constituting the seal member 32, for example, 2 g/10 min or less or 1 g/10 min or less, it is possible to more effectively suppress the resin material from spreading to the active material layer side on the surface of the current collector 21 against heating and pressurization in the lamination direction D by heaters 41 and 41 when the seal member 32 is welded to the current collector 21.

In general, a melt mass flow rate of a resin material has a relationship opposite to a molecular weight of the resin material. As the molecular weight increases, a boiling point and a melting point of the resin material tend to increase, and the melt mass flow rate tends to decrease. As the molecular weight decreases, the boiling point and the melting point of the resin material tend to decrease, and the melt mass flow rate tends to increase. Therefore, adjustment of the melt mass flow rate of the resin material constituting the seal member 32 and adjustment of the melt mass flow rate of the resin material constituting the spacer 31 can be performed, for example, by adjusting a molecular weight of a main agent of the resin material. The melt mass flow rate can also be adjusted by containing an auxiliary material such as an elastomer.

In manufacturing the power storage device 1 as described above, a plurality of current collectors 21 provided with the positive electrode active material layer 23 and the negative electrode active material layer 24 are prepared. Next, in the edge portions 21c of the respective current collectors 21, the seal members 32 are welded to each of the first surface 21a and the second surface 21b. Next, the current collectors 21 to which the seal members 32 are welded are laminated with the spacers 31 interposed therebetween. Then, the outer edge portion 31a including the end surface of each of the laminated spacers 31 and the outer edge portion 32a including the end surface of each of the seal members 32 are welded to each other to form the welded portion W, and the sealing body 3 is formed by the spacers 31 and the seal members 32.

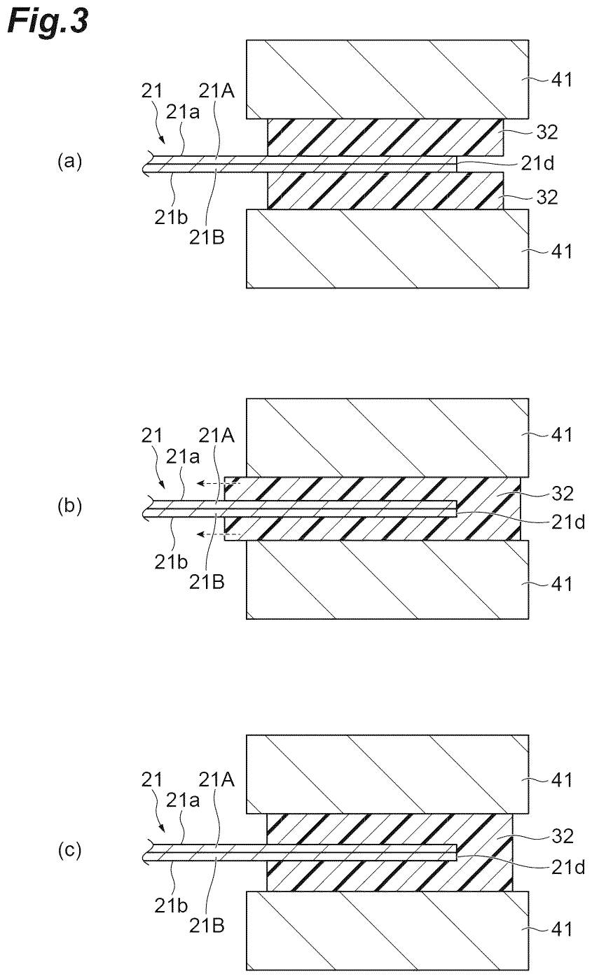

In the above process, when the seal member 32 is fused to the current collector 21, for example, as illustrated in FIG. 3(a), the frame-like seal members 32 are disposed on each of the first surface 21a side and the second surface 21b of the edge portion 21c of the current collector 21, and the edge portion 21c of the current collector 21 and the seal members 32 on both surfaces are sandwiched between the heaters 41 and 41 to be heated and pressurized.

In welding the seal member 32 to the current collector 21, when the melt mass flow rate of the resin material constituting the seal member 32 is equal to or larger than the melt mass flow rate of the resin material constituting the spacer 31, as illustrated in FIG. 3(b), the seal member 32 is heated and pressurized in the lamination direction D (thickness direction of the seal member 32) by the heaters 41 and 41, so that it is considered that the resin material spreads to the active material layer side on the surface of the current collector 21. When the resin material spreads to the active material layer side, the thickness of the seal member 32 varies depending on the degree of spread, and the shape of the seal member 32 in the thickness direction after welding becomes unstable. As a result, it is considered that a short circuit occurs due to contact between the current collectors 21 and 21 adjacent to each other in the lamination direction D. When the thickness of the seal member 32 after welding becomes insufficient, it is considered that welding of the end portion 13a of the separator 13 to the seal member 32 is also affected.

On the other hand, in the power storage device 1, since the melt mass flow rate of the seal member 32 welded to the current collector 21 is suppressed, as illustrated in FIG. 3(c), when the seal member 32 is welded to the current collector 21, it is possible to suppress the resin material from spreading to the active material layer side on the surface of the current collector 21 against the heating and pressurization in the lamination direction D by the heaters 41 and 41. Therefore, in the power storage device 1, the dimension in the thickness direction of the seal member 32 after welding can be stabilized, and the interval between the current collectors 21 and 21 in the lamination direction D can be suitably maintained. Therefore, a short circuit due to the contact between the current collectors 21 and 21 can be suitably prevented. In addition, since the thickness of the seal member 32 after welding is sufficiently secured, welding between the seal member 32 and the end portion 13a of the separator 13 can also be suitably performed.

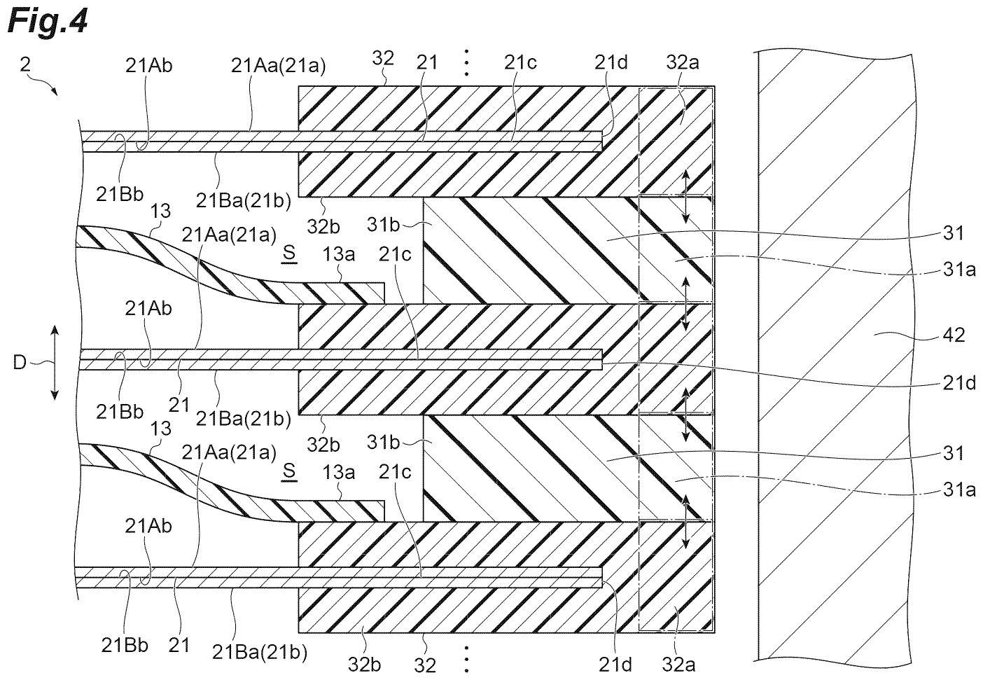

In the above process, for example, as illustrated in FIG. 4, an infrared heater 42 is used for welding between the outer edge portion 31a of each spacer 31 and the outer edge portion 32a of each seal member 32. In the example of FIG. 4, the infrared heater 42 is disposed to be separated from the outer edge portion 31a of each spacer 31 and the outer edge portion 32a of each seal member 32, and heats the outer edge portion 31a including the end surface of each spacer 31 and the outer edge portion 32a including the end surface of each seal member 32 in a non-contact manner from a direction intersecting the lamination direction D (thickness direction of the spacer 31).

The outer edge portion 31a of each spacer 31 and the outer edge portion 32a of each seal member 32 are restrained in the lamination direction D and heated in a state of being in close contact with each other. In the spacer 31 and the seal member 32 adjacent to each other in the lamination direction D, the outer edge portion 31a of each spacer 31 melted by heating and the outer edge portion 32a of each seal member 32 melted by heating are welded to each other to form the welded portion W. In the welding between the outer edge portion 31a of each spacer 31 and the outer edge portion 32a of each seal member 32, when the melt mass flow rate of the resin material constituting the spacer 31 is equal to or smaller than the melt mass flow rate of the resin material constituting the seal member 32, the fluidity of both the spacer 31 and the seal member 32 adjacent to each other in the lamination direction D decreases. As a result, it is considered that the compatibility between the spacer 31 and the seal member 32 is insufficient, and the sealability of the space S between the current collectors 21 and 21 by the sealing body 3 becomes insufficient.

On the other hand, in the power storage device 1, the melt mass flow rate of the resin material constituting the spacer 31 is larger than the melt mass flow rate of the resin material constituting the seal member 32. By increasing the melt mass flow rate of the resin material constituting the spacer 31, the fluidity of each spacer 31 when the outer edge portion 31a of each spacer 31 and the outer edge portion 32a of each seal member 32 are welded can be enhanced. Therefore, the compatibility between the spacer 31 and the seal member 32 is sufficiently enhanced, and the sealability of the sealing body 3 can be further enhanced.

In the present embodiment, as illustrated in FIG. 4, each spacer 31 is heated by the infrared heater 42 from the direction intersecting the lamination direction D (thickness direction of the spacer 31), and only the outer edge portion 31a of the spacer 31 is melted and welded to the outer edge portion 32a of the seal member 32. Therefore, even when the melt mass flow rate of the resin material constituting the spacer 31 is equal to or larger than the melt mass flow rate of the resin material constituting the seal member 32, the inner edge portion 31b of the spacer 31 between the current collectors 21 and 21 is not melted at the time of welding to the seal member 32, so that it is possible to avoid an influence on the thickness dimension of the spacer 31 for preventing a short circuit between the current collectors 21 and 21 adjacent to each other in the lamination direction D.

In the power storage device 1, the thickness T2 of the spacer 31 is larger than the thickness T1 of the seal member 32. When the outer edge portion 31a of each spacer 31 and the outer edge portion 32a of the seal member 32 are welded, since the thickness of the spacer 31 having a melt mass flow rate larger than that of the seal member 32 is larger than that of the seal member 32, the compatibility between the seal member 32 and the spacer 31 can be more sufficiently secured. Therefore, welding between the respective outer edge portions 31a of the spacers 31 and the respective outer edge portions 32a of the seal member 32 is facilitated, and the sealability of the sealing body 3 can be further enhanced.

In the power storage device 1, the seal member 32 is welded to each of the first surface 21a and the second surface 21b of the current collector 21. As a result, it is possible to prevent the electrolyte solution from flowing around to another surface of the current collector 21 and to suppress an occurrence of electrolytic corrosion. Even when the seal member 32 is disposed on each of the first surface 21a and the second surface 21b of the current collector 21 and then welding is performed by pressurizing and heating from both the first surface 21a side and the second surface 21b side, since the melt mass flow rate of the seal member 32 welded to the current collector 21 is smaller than the melt mass flow rate of the resin material constituting the spacer 31, it is possible to sufficiently suppress the spread of the resin material when the seal member 32 is welded to the current collector 21. Therefore, the stability of the dimension in the thickness direction of the seal member 32 after welding can be more suitably maintained.

### REFERENCE SIGNS LIST

1 Power storage device
2 Electrode laminate
3 Sealing body
3a Outer surface
21 (21A, 21B) Current collector
14 Bipolar electrode
21a First surface
21b Second surface
23 Positive electrode active material layer (active material layer)
24 Negative electrode active material layer (active material layer)
31 Spacer
31a Outer edge portion
31b Inner edge portion
32 Seal member
32a Outer edge portion
32b Inner edge portion
D Lamination direction
T1 Thickness of seal member
T2 Thickness of spacer

1. A power storage device comprising:
an electrode laminate formed by laminating a plurality of bipolar electrodes including a pair of electrodes configured by a current collector and active material layers provided on a first surface and a second surface of the current collector; and
a sealing body configured to seal a side surface extending in a lamination direction of the bipolar electrodes in the electrode laminate, wherein
the sealing body has a plurality of frame-like seal members welded to each edge portion of the current collector, and a plurality of frame-like spacers disposed between the seal members adjacent to each other in the lamination direction,
an outer edge portion protruding farther outward than the edge portion of the current collector in each of the spacers and an outer edge portion protruding farther outward than the edge portion of the current collector in each of the seal members adjacent to each of the spacers in the lamination direction are welded to each other to form an outer surface of the sealing body, and
a melt mass flow rate of a resin material constituting the spacer is larger than a melt mass flow rate of a resin material constituting the seal member.

2. The power storage device according to claim 1, wherein a thickness of the spacer is larger than a thickness of the seal member.

3. The power storage device according to claim 1, wherein the seal member is welded to each of the first surface and the second surface of the current collector.
